(19) United States
(12) Patent Application Publication
(10) Pub. No.: US 2011/0039076 A1
(43) Pub. Date: Feb. 17, 2011

(54) Optical wiring board having a core

(75) Inventors: Joon-Sung Kim, Suwon-si (KR); Je-Gwang Yoo, Yongin-si (KR); Chang-Sup Ryu, Yongin-si (KR); Han-Seo Cho, Yuseong-gu (KR); Sang-Hoon Kim, Gunpo-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/923,993

(22) Filed: Oct. 19, 2010

Related U.S. Application Data
(62) Division of application No. 12/149,952, filed on May 9, 2008.

(30) Foreign Application Priority Data
Nov. 16, 2007 (KR) 10-2007-0117286

(51) Int. Cl. B32B 3/00

(52) U.S. Cl. 428/172

(57) ABSTRACT

An optical wiring board having a core, the optical wiring board including: a lower cladding; a side cladding formed over the lower cladding and having an indentation formed therein, the indentation being in correspondence with the core; a core embedded in the indentation; and an upper cladding covering the core, wherein a height of the core is different from a depth of the indentation

### CROSS-REFERENCE TO RELATED APPLICATIONS

This application is a U.S. divisional application filed under 37 USC 1.53(b) claiming priority benefit of U.S. Ser. No. 12/149,952 filed in the United States on May 9, 2008, which claims earlier priority benefit to Korean Patent Application No. 10-2007-0117286 filed with the Korean Intellectual Property Office on Nov. 16, 2007, the disclosures of which are incorporated herein by reference.

### BACKGROUND

1. Field

The present invention relates to an optical wiring board and a method of manufacturing the optical wiring board.

2. Description of the Related Art

The technology of manufacturing a printed circuit board using copper wiring is reaching its limit, because of the increasing speeds and capacities required for transferring and storing data. Accordingly, the optical wiring board, which includes optical wiring, is receiving attention as an alternative for overcoming the problems of electrical copper wiring.

An optical waveguide, which can deliver optical signals using polymers or optical fibers, may be inserted in the optical wiring board. This is referred to as an EOCB (Electro-Optical Circuit Board). The EOCB can be used in the transceiving equipment and switching equipment of a communication network, the switches and servers of a data communication system, the mobile base stations of an UMTS (Universal Mobile Telecommunication System), or in the backplanes and daughter boards of a super computer.

One method of forming the optical waveguide includes forming a lower cladding, forming a core over the lower cladding, and forming an upper cladding over the core. According to this method, however, the core may be polluted, and it is difficult to form the upper cladding to a uniform thickness.

### SUMMARY

An aspect of the invention provides an optical wiring board and a method of manufacturing the optical wiring board, with which the thickness of the core can be controlled easily.

Another aspect of the invention provides a method of manufacturing an optical wiring board that includes a core. The method includes forming a lower cladding over an insulating layer; forming a side cladding, which has an indentation corresponding with the core, over the lower cladding; filling a core material in the indentation; and forming an upper cladding such that the core material is covered.

Additionally, the method may further include forming a pad over an upper side or a lower side of the insulating layer, before forming the lower cladding.

The forming of the side cladding may include forming a cladding layer over the lower cladding and forming an indentation by processing the cladding layer.

Here, the operation of hardening the lower cladding may be performed additionally before the forming of the cladding layer, and the indentation may be formed by wet etching.

The core material may be filled by an ink-jet method, and a height of the core material filled in the indentation may be smaller than a depth of the indentation. In certain embodiments, the upper cladding may be formed only in the indentation.

Conversely, a height of the core material filled in the indentation may be greater than a depth of the indentation, and the lower cladding and the side cladding may be made from different materials.

Yet another aspect of the invention provides an optical wiring board having a core. The optical wiring board can include a lower cladding; a side cladding, which is formed over the lower cladding, and in which an indentation corresponding with the core is formed; a core embedded in the indentation; and an upper cladding covering the core. Here, a height of the core may be different from a depth of the indentation.

The height of the core may be smaller than the depth of the indentation, and in certain embodiments, the upper cladding may be formed only in the indentation.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a flowchart of a manufacturing method of an optical wiring board according to an embodiment of the present invention.

FIG. 2, FIG. 3, FIG. 4, FIG. 5, FIG. 6, and FIG. 7 are cross-sectional views representing processes of a method of manufacturing an optical wiring board according to an embodiment of the present invention.

FIG. 8, FIG. 9, and FIG. 10 are cross-sectional views of an optical wiring board according to another embodiment of the present invention.

FIG. 11, FIG. 12, FIG. 13, FIG. 14, FIG. 15, and FIG. 16 are cross-sectional views representing processes of a manufacturing method of an optical wiring board according to still another embodiment of the present invention.

### DESCRIPTION OF EMBODIMENTS

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first” and “second,” etc., may be used to describe various components, such components must not be limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

The optical wiring board and the method of manufacturing the optical wiring board according to certain embodiments of the invention will be described below in more detail with reference to the accompanying drawings. Those components that are the same or are in correspondence are rendered the same reference numeral regardless of the figure number, and redundant explanations are omitted.

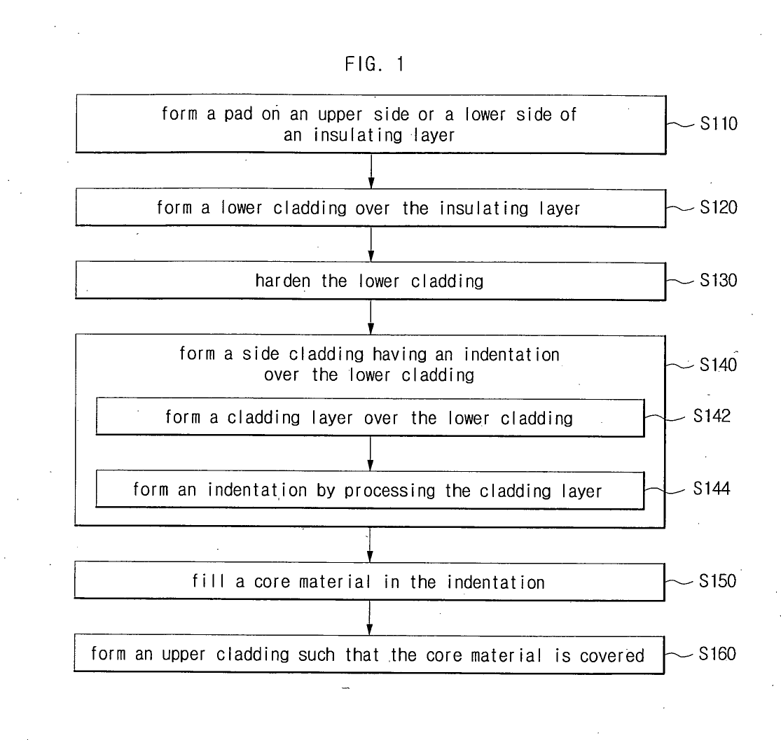

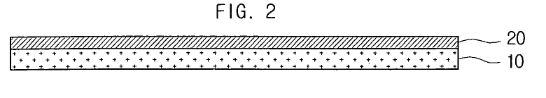

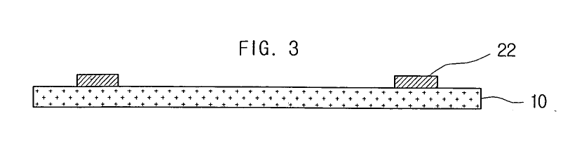

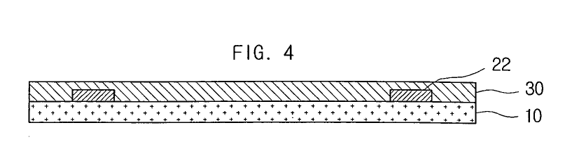

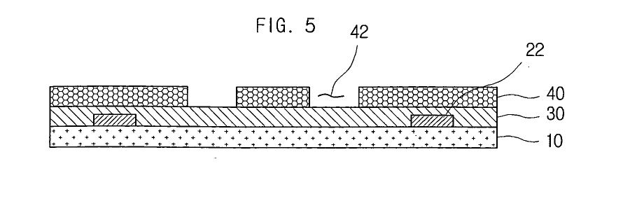

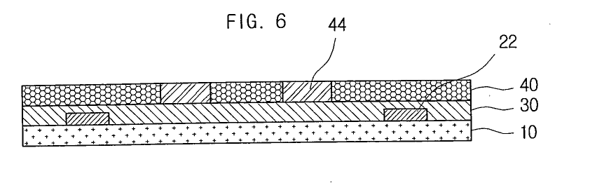

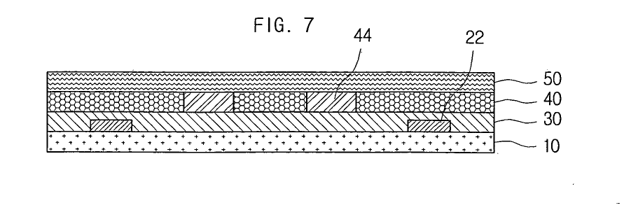

FIG. 1 is a flowchart of a manufacturing method of an optical wiring board according to an embodiment of the present invention, and FIG. 2 through FIG. 7 are cross-sectional views representing processes of a method of manufacturing an optical wiring board according to an embodiment of the present invention. In FIG. 2 through FIG. 7 are illustrated an insulating layer 10, a metal layer 20, pads 22, a lower cladding 30, a side cladding 40, indentations 42, cores 44, and an upper cladding 50.

First, pads 22 can be formed over an upper side or a lower side of an insulating layer 10 (S110). For this, an insulating 10 layer on which a metal layer 20 is formed may be prepared, as shown in FIG. 2, and the metal layer 20 may be selectively removed, as shown in FIG. 3.

Next, a lower cladding 30 can be formed over the insulating layer 10 (S120), and hardened (S130). The lower cladding 30 may be made of materials such as polyimide, and epoxy or acrylic materials, with additives added to control the refractive index.

Then, a side cladding 40 having indentations 42 formed in correspondence with the cores 44 can be formed over the lower cladding 30 (S140). For this, a cladding layer (not shown) may be formed over the lower cladding 30 (S142), after which the indentations 42 may be formed by processing the cladding layer (not shown) (S144).

A material of film-type may be stacked, or a material of ink-type may be dispensed so that the cladding layer (not shown) is formed over the lower cladding 30.

The cladding layer (not shown) may be made of materials such as polyimide, epoxy, or acrylic materials, to which additives may be added for controlling the refractive index.

The indentations 42 may be formed by wet etching. That is, an exposure process may be performed for the cladding layer (not shown) with a mask (not shown) blocking the beams, after which an etchant may be provided to the cladding layer (not shown). Using wet etching to etch the unhardened or semi-hardened cladding layer formed over the already hardened lower cladding 30 reduces the risk of damage to the lower cladding 30, thereby allowing a facilitated operation.

In this way, the side cladding may 40 be formed after the lower cladding 30 is hardened. Other methods may also be used, some of which can include forming the side cladding 40 from a different material from that of the lower cladding 30. Thus, when the wet etching is performed for forming the indentations 42, chemical reactions between the etchant and the lower cladding 30 can be prevented. This can reduce the risk of damage to the lower cladding 30 during the forming of the indentations 42. In certain examples, the lower cladding 30 can be made of an acrylic material, while the side cladding 40 can be made of polyimide.

After forming the side cladding 40 having the indentations 42 through the processes described above, the cores 44 may be formed by filling a core material in the indentations 42 (S150), as shown in FIG. 6. Then, as shown in FIG. 7, an upper cladding 50 may be formed such that the core material is covered (S160). The core material can be filled in using an ink-jet method.

The core material may be made of an uncured polyimide, epoxy, or acrylic material. The core material may be cured later to form the cores 44.

The cores 44 can serve as paths through which optical signals may be transferred, and can be surrounded by the lower cladding 20, upper cladding 50, and side cladding 40. Here, the cores 44 may have a higher refractive index compared to the lower cladding 20, upper cladding 50, and side cladding 40, for the efficient transmission of optical signals. The core may thus contain additives for controlling the refractive index.

Since the cores may be formed by filling and curing the core material in the indentations 42 of the side cladding 40, the thickness of the cores 44 may readily be controlled by controlling the thickness of the side cladding 40. Also, by using an ink-jet method, the high-cost core materials may not be wasted.

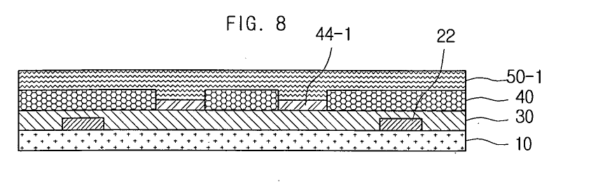

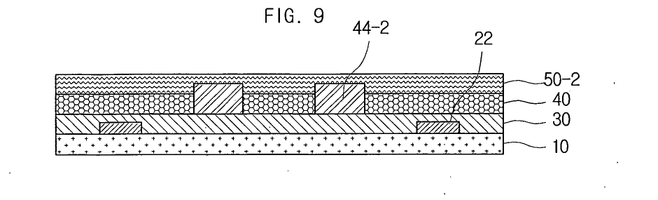

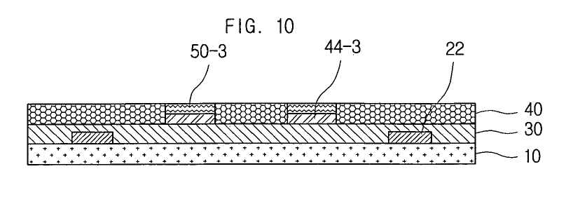

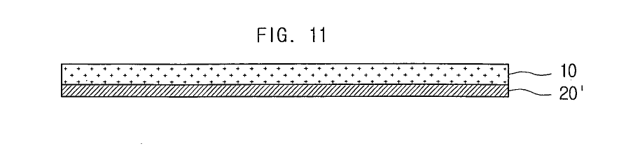

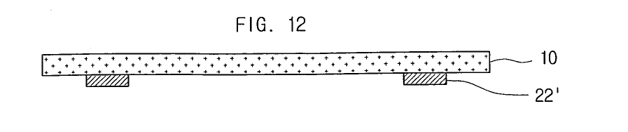

While it is possible to completely fill indentations 42 with the core material such as in the example shown in FIG. 6, the core material 44-1 may also be only partially filled in the indentations 42 before forming the upper cladding 50-1, such as in the example shown in FIG. 8. It is also possible to overfill the core material 44-2 in the indentations 42 and then form the upper cladding 50-2, such as in the example shown in FIG. 9. In other words, the height of the core material filled in the indentations 42 may be greater than the depth of the indentations 42, or may be smaller than the depth of the indentations 42.

In addition, the core material 44-3 can be filled in only a part of the indentations 42, with the upper cladding 50-3 formed only in the indentations 42, as shown in FIG. 10.

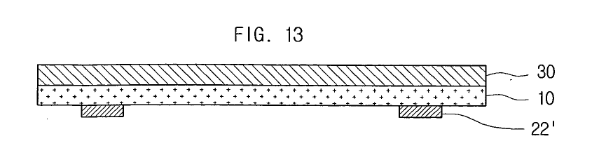

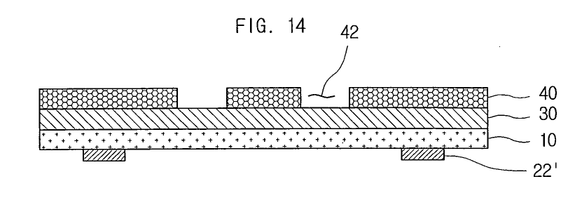

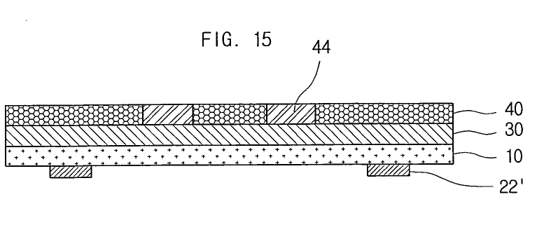

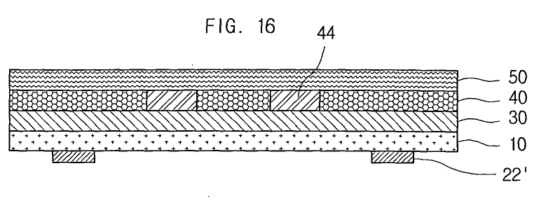

FIG. 11 through FIG. 16 are cross-sectional views representing processes of a method of manufacturing an optical wiring board according to another embodiment of the present invention. Compared to the embodiment described above, one difference of this embodiment lies in the positions of the pads 22, 22′.

That is, in the embodiment described above, the pads 22 may be buried in the lower cladding 30, as shown in FIG. 7. In this embodiment, however, the pads 22′ may not be buried in the lower cladding 30, but may be formed on the lower side of the insulating layer 10, so that the pads 22′ may be exposed.

For this, an insulating layer 10 on which a metal layer 20′ such as of copper is stacked may be prepared as shown in FIG. 11, and pads 22′ may be formed underneath the insulation layer 10 (S110) as shown in FIG. 12, for example, by selectively etching the metal layer 20′.

Then, as illustrated in FIG. 13, the lower cladding 30 may be formed over the insulating layer 10 (S120), and the lower cladding 30 may be hardened (S130).

Next, the side cladding 40 having indentations 42 formed in correspondence with the core 44 can be formed over the lower cladding 30 (S140), as shown in FIG. 14, and the core material can be filled in the indentations 42 (S150), as shown in FIG. 15. Afterwards, as shown in FIG. 16, the upper cladding 50 may be formed over the side cladding 40 such that the indentations 42 are covered (S160).

A manufacturing method of an optical wiring board according to an aspect of the present invention is set forth above, and an optical wiring board manufactured by the method is illustrated in FIG. 7 through FIG. 10 and FIG. 16.

The optical wiring board may include a lower cladding 30, a side cladding 40 in which one or more indentations 42 can be formed, one or more cores 44, 44-1, 44-2, 44-3 embedded in the indentations 42, and an upper cladding 50, 50-1, 50-2, 50-3 covering the cores 44.

The height of the cores 44 may be equal to the depth of the indentations 42, as shown in FIG. 7 and FIG. 16, or may be different from the depth of the indentations 42, as shown in FIG. 8 through FIG. 10.

In particular, if the height of the cores 44 is smaller than the depth of the indentations 42, it is possible to form the upper cladding 44-3 only in the indentations 42. This can reduce the overall thickness of the optical wiring board.

The functions of and manufacturing method for each component can be substantially the same as those of each component in the previously described embodiment. As such, the description of these will not be repeated.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. An optical wiring board having a core, the optical wiring board comprising:
a lower cladding;
a side cladding formed over the lower cladding and having an indentation formed therein, the indentation being in correspondence with the core;
a core embedded in the indentation; and
an upper cladding covering the core,
wherein a height of the core is different from a depth of the indentation.

2. The optical wiring board of claim 1, wherein a height of the core is smaller than a depth of the indentation.

3. The optical wiring board of claim 2, wherein the upper cladding is formed in the indentation only.
